(19) United States
(12) Patent Application Publication
(10) Pub. No.: US 2017/0187178 A1
(43) Pub. Date: Jun. 29, 2017

(54) METHOD AND SYSTEM FOR PROTECTING ELECTRONIC DEVICE

(71) Applicant: Xiaomi Inc., Beijing (CN)

(72) Inventors: Dongxu LIU, Beijing (CN); Xiaobo HUANG, Beijing (CN); Ling XU, Beijing (CN)

(73) Assignee: Xiaomi Inc.

(21) Appl. No.: 15/383,153

(22) Filed: Dec. 19, 2016

(30) Foreign Application Priority Data
Dec. 25, 2015 (CN) 201510997203.7

(51) Int. Cl. H02H 3/02; H02H 3/00

(52) U.S. Cl. CPC H02H 3/021; H02H 3/006

(57) ABSTRACT

The present disclosure provides a method and a system for protecting an electrical device. The method includes: acquiring coordinate data of the electronic device; determining whether the coordinate data exceeds a data range corresponding to a preset state of the electronic device; and disabling the electronic device when the coordinate data exceeds the data range corresponding to the preset state.

### CROSS-REFERENCE TO RELATED APPLICATION

This application is based upon and claims priority to Chinese Patent Application No. 201510997203.7, filed Dec. 25, 2015, the entire contents of which are incorporated herein by reference.

### TECHNICAL FIELD

The present disclosure generally relates to the field of device control technology and, more particularly, to a method and a system for protecting an electronic device.

### BACKGROUND

Electric fan is a common household appliance. When the electric fan is running, it may be accidentally knocked down and/or occasionally moves its position. If the fan continues running when these events occur, safety issues may arise. Moreover, objects around the fan may be sucked into the fan or blown away, which may cause damages to the fan and a mess in the room.

Conventionally, the electric fan is connected to a power source via a pressured contact. When the fan falls down, the contact is open and the power is cut off. However, the pressured contact has a low sensitivity and may be inactive during a fall of the fan. Moreover, this conventional method may not predict whether the fan will fall down and thus cannot forewarn a fall of the fan. As such, the user cannot know the current state of the fan timely, nor can the user be informed of an impending situation associated with the fan.

### SUMMARY

According to a first aspect of the present disclosure, there is provided a method for protecting an electronic device, comprising: acquiring coordinate data of the electronic device; determining whether the coordinate data exceeds a data range corresponding to a preset state of the electronic device; and disabling the electronic device when the coordinate data exceeds the data range corresponding to the preset state.

According to a second aspect of the present disclosure, there is provided a system for protecting an electronic device, comprising: a processor; and a memory configured to store instructions executable by the processor; wherein the processor is configured to: acquire coordinate data of the electronic device; determine whether the coordinate data exceeds a data range corresponding to a preset state of the electronic device; and disable the electronic device when the coordinate data exceeds the data range corresponding to the preset state.

According to a third aspect of the present disclosure, there is provided an electronic device, comprising: a processor; and a memory configured to store instructions executable by the processor; wherein the processor is configured to: acquire coordinate data of the electronic device; determine whether the coordinate data exceeds a data range corresponding to a preset state of the electronic device; and disable the electronic device when the coordinate data exceeds the data range corresponding to the preset state.

It is to be understood that both the foregoing general description and the following detailed description are exemplary and explanatory only and are not restrictive of the present disclosure.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flowchart of a method for protecting an electronic device, according to an exemplary embodiment of the present disclosure.

FIG. 2 is a schematic diagram illustrating states of a state machine, according to an exemplary embodiment of the present disclosure.

FIG. 3 is a flowchart of a method for determining state switching of a state machine, according to an exemplary embodiment of the present disclosure.

FIG. 4 is a flowchart of a method for protecting an electronic device, according to an exemplary embodiment of the present disclosure.

FIG. 5 is a block diagram of a system for protecting an electronic device, according to an exemplary embodiment of the present disclosure.

FIG. 6 is a block diagram of an electronic device, according to an exemplary embodiment of the present disclosure.

### DETAILED DESCRIPTION

Now the exemplary embodiments will be described fully with reference to the accompanying drawings. However, the exemplary embodiments may be implemented with a variety of forms, and are not understood as limiting examples. Instead, these exemplary embodiments provided will make the present disclosure more comprehensive and complete, and conceptions of the exemplary embodiments will convey fully to those skilled in the art. The accompanying drawings are merely schematic illustrations and are not drawn in proportion. The same numbers in accompanying drawings represent the same or similar elements, and thereby their description may not be repeated.

Furthermore, described features, structures, or characteristics may be combined in one or more embodiments by any suitable manner. In the following description, numerous specific details are provided to give full understandings of the embodiments of the present disclosure. However, those skilled in the art will appreciate that, technical solutions provided in the resent disclosure may be practiced but omitting one or more specific details, or by other methods, components, apparatus, steps, etc. In other cases, well-known structures, methods, apparatus, implements, materials, or operations will not be shown or described to avoid distractions that make aspects of the present disclosure become vague.

Some block diagrams shown in the accompanying drawings are functional entities that are not necessary to correspond to physically or logically separate entities. These functional entities may be implemented as software, one or more hardware modules or integrated circuits, network devices, processor devices, and/or microcontroller devices.

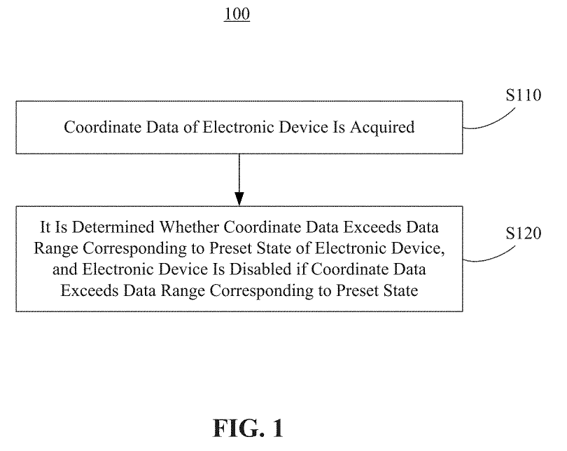

FIG. 1 is a flowchart of a method 100 for protecting an electronic device, according to an exemplary embodiment of the present disclosure. Referring to FIG. 1, the method 100 includes the following steps S110 and S120.

In step S110, coordinate data of the electronic device is acquired.

The coordinate data of the electronic device may be acquired by a gravity sensor mounted on the electronic device. The coordinate data includes a vertical coordinate and/or a horizontal coordinate of the electronic device. The vertical coordinate and/or the horizontal coordinate may be used as the basis for determining the state of the electronic device.

In step S120, it is determined whether the coordinate data exceeds a data range corresponding to a preset state of the electronic device. If the coordinate data exceeds the data range, the electronic device is disabled.

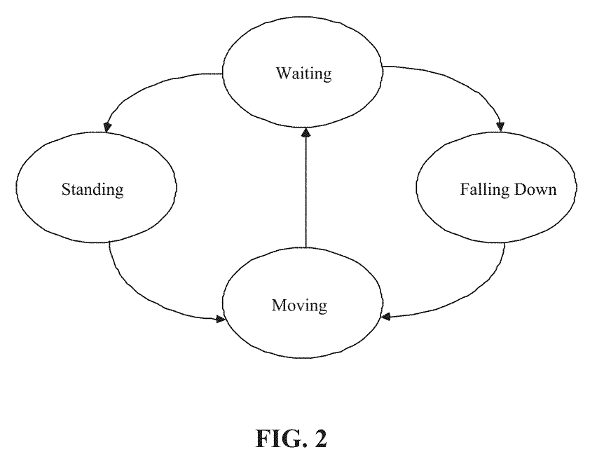

In exemplary embodiments, the determining and switching of the state of the electronic device may be performed according to the coordinate data and change of the coordinate data. FIG. 2 is a schematic diagram illustrating states of a state machine, according to an exemplary embodiment of the present disclosure. For example, the state machine may be the electronic device described in with method 100 (FIG. 1). Referring to FIG. 2, the electronic device may have four states, namely, standing, falling down, moving, and waiting. The “preset state” used in the present disclosure refers to the standing state. The standing state is a normal state of the electronic device. That is, in the standing state, the electronic device can operate as desired. Once the electronic device moves its position or shakes, the electronic device enters into the moving state. If the amount of moving and/or shaking during the moving state is minor, e.g., below a predetermined level, the electronic device may be considered to be in the waiting state. In the waiting state, the vertical coordinate of the electronic device may be used to determine whether the electronic device is in the standing state or the falling down state.

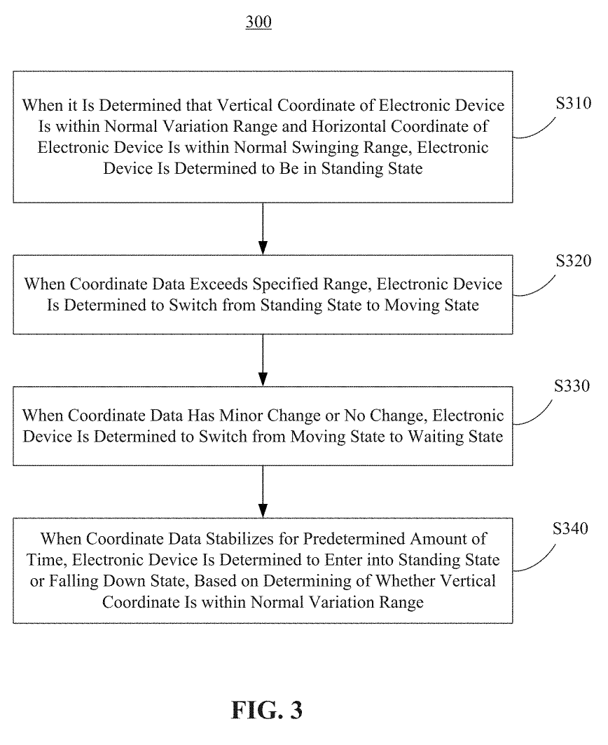

FIG. 3 is a flowchart of a method 300 for determining state switching of a state machine, according to an exemplary embodiment. For example, the state machine may be an electronic device, such as an electric fan. The method 300 may be performed by a part or whole of the electronic device. As shown in FIG. 3, the method 300 may include the following steps S310-S340.

In step S310, when it is determined that a vertical coordinate of the electronic device is within a normal variation range and a horizontal coordinate of the electronic device is within a normal swinging range, the electronic device is determined to be in a standing state.

The vertical coordinate and the horizontal coordinate in collection constitute the coordinate data describing the spatial position of electronic device. For example, the coordinate data may be expressed in the form of Q (x, y, z), where Q denotes a geometrical center or gravity center of the electronic device.

The aforementioned “normal variation range” may be vertical coordinates (represented by “z”) inherently determined by the design of the electronic device. In some embodiments, the vertical coordinates may be values generated by sensors configured to measure the position change of the electronic device and correspond to the electronic device's actual position or height according to a predetermined relationship. For example, if the electronic device is a height-adjustable console type electric fan, the normal variation range of the vertical coordinate z may be −255-−180, which may be set by the manufacturer of the electronic device and correspond to the normal adjustable range of the height. In the disclosed embodiments, the horizontal coordinates may be similarly defined.

Since a part of the electronic device, such as the head of an electric fan, may swing during a normal operation state of the electronic device, the horizontal coordinate may also have a “normal swinging range,” which may vary depending on the dimensions of different electronic devices. As described above, when the vertical coordinate and the horizontal coordinate of the electronic device are within the normal variation range and the normal swinging range respectively, the electronic device may be determined to be in the standing state.

In step S320, when the coordinate data exceeds a specified range, the electronic device is determined to switch from the standing state to a moving state. In the disclosed embodiments, step S320 may be performed according to one of the following three implementations.

In a first implementation, the switching of the state may be determined based on the vertical coordinate's change in time. Specifically, when it is determined that the change of the vertical coordinate z has exceeded a first preset range for a predetermined amount of time, the electronic device is determined to switch from the standing state to the moving state.

The change of the vertical coordinate may indicate the shaking of the electronic device. The shaking may be caused by, for example, the motor of the electronic device. If the shaking is minor, i.e., if the change of the vertical coordinate does not exceed the first preset range, the electronic device may still be in the standing state. Moreover, if the shaking of the electronic device exceeds the first preset range for a number of times, but the number is less than a predetermined value, this may only suggest that the shaking is probably caused by the instability of the motor and thus cannot be used as the basis for concluding the electronic device has moved.

Therefore, the magnitude and the lasting duration of the shaking should be considered simultaneously. For example, if the shaking of the vertical coordinate has exceeded the first preset range, e.g., −20 −20, for 5 times, the electronic device may be considered to switch from the standing state to the moving state. In practice, the shaking of the electronic device may be sampled at a preset time interval. The time during which the shaking lasts is a product of the sampling interval and the number of sampling times. For example, if the sampling interval is 100 ms and the number of the sampling times is 5, then the shaking has lasted for about 5*100 ms=500 ms. If 500 ms is equal to or above the predetermined amount of time, the electronic device may be determined to switch from the standing state to the moving state.

In a second implementation, the switching of the state may be determined directly based on whether the vertical coordinate exceeds the normal variation range. Specifically, when the change of the vertical coordinate z exceeds a second preset range, the electronic device is determined to switch from the standing state to the moving state. There is no need to further determine whether the deviation from the second preset range lasts for a predetermined amount time. For example, the second preset range may be defined as −255-255, in which the electronic device may operate normally. In exemplary embodiments, the second preset range may be larger than the first preset range.

In a third implementation, the switching of the state may be determined based on the horizontal coordinate's change in time. Specifically, when the horizontal coordinate (i.e., x and/or y) exceeds a third preset range for a predetermined amount of time, the electronic device is determined to switch from the standing state to the moving state.

Similar to the first implementation, it is determined whether the change of the horizontal coordinate has exceeded the third preset range for a predetermined amount of time. For example, if the shaking of the horizontal coordinate (x and/or y) exceeds the third preset range, e.g., −40-40 for 5 times, the state of the electronic device is determined to switch from the standing state to the moving state. Similar to the example described in connection with the first implementation, if the sampling interval for the shaking is 100 ms, the time duration for shaking 5 times is about 5*100 ms=500 ms. If 500 ms is equal to or above the predetermined amount of time, the electronic device may be determined to switch from the standing state to the moving state.

While the change of the coordinate data Q (x, y, z) continues after it is determined that the electronic device has entered into the moving state, the electronic device may be determined to stay in the moving state.

With continued reference to FIG. 3, in step S330, when the coordinate data has only minor change or no change, the electronic device is determined to switch from the moving state to a waiting state.

For example, the standard for “minor” change may be: the change of each of the horizontal coordinate and the vertical coordinate is within a range of −20-20 and occurs no more than 5 times within a given amount of time. If the change is determined to be minor according to this standard, the electronic device is considered to switch from the moving state to the waiting state.

Still referring to FIG. 3, in step S340, when the coordinate data stabilizes for a predetermined amount of time, the electronic device is determined to enter into the standing state or a falling down state, based on determining of whether the vertical coordinate is within the normal variation range.

In some embodiments, the duration of the waiting state is short, e.g., 1-3 seconds. That is, when the coordinate data is determined to have been stable for 1-3 seconds, it may be further determined whether the electronic device is in the standing state or the falling down state, based on the vertical coordinate. If the vertical coordinate is within the normal variation range, the electronic device is determined to enter into the standing state. If the vertical coordinate is outside the normal variation range, the electronic device is determined to enter into the falling down state.

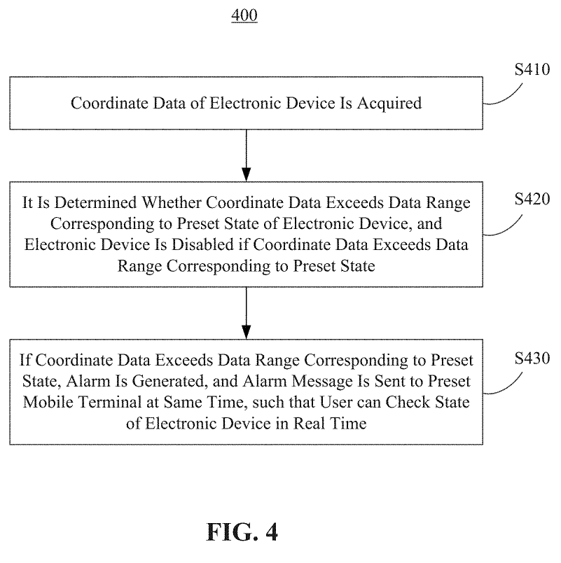

FIG. 4 is a flowchart of a method 400 for protecting an electronic device, according to an exemplary embodiment of the present disclosure. For example, the method 400 may be performed by the electronic device itself. Referring to FIG. 4, the method 400 may include the following steps S410-S430.

Steps S410 and S420 are similar to steps S110 and S120 (FIG. 1), respectively. Moreover, in step S430, if the coordinate data exceeds the data range corresponding to the preset state, i.e., the standing state, the electronic device generates an alarm, and sends an alarm message to a preset mobile terminal at the same time, such that a user of the preset device can check the state of the electronic device in real time.

Consistent with the disclosed embodiments, the electronic device works normally in the standing state. If the state of the electronic device switches from the standing state to the moving state, the electronic device shuts down and generates an alarm (e.g., a long beeping sound). Meanwhile, the electronic device may send the alarm message to the preset mobile terminal (e.g., a mobile phone) of the user. The user may check the state of the electronic device remotely and in real time, via an application in the mobile phone.

In the disclosed embodiments, the electronic device may communicate with the preset mobile terminal via a wireless network based on any suitable communication standard, such as Bluetooth, WiFi, 2G, 3G, 4G, or a combination thereof.

The method 400 may be applied to any electronic device that has a standing or a stable state and needs to be monitored whether the electronic device falls down to the ground. As an example, the method 400 may be used to protect a fan, such as a console type fan, a table fan, or a fan that can remain in a standing state after being fixed at a position by certain clamping or fixing mechanism.

According to the method 400, the coordinate data of the electronic device is collected via the gravity sensor, and analyzed to determine the state switching of the electronic device. As such, the method 400 can determine in real time that the electronic device is about to fall down to the ground, so as to timely cut off the power and disable the electronic device. The method 400 has a high sensitivity, thus can effectively prevent the electronic device from running after the electronic device falls down to the ground and avoid the related safety issues. When the electronic device departs from the standing state, the electronic device may also issue an alarm to remind surrounding people timely, and further send an alarm message to the mobile terminal for a user to check the state of the electronic device remotely and in real time.

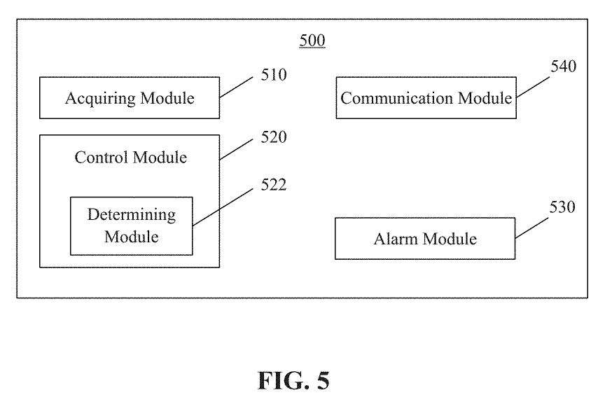

FIG. 5 is a block diagram of a system 500 for protecting an electronic device, according to an exemplary embodiment of the present disclosure. As shown in FIG. 5, the system 500 includes an acquiring module 510, a control module 520, an alarm module 530, and a communication module 540.

The acquiring module 510 is configured to acquire coordinate data of the electronic device. The acquiring module 510 may obtain the coordinate data of the electronic device via a gravity sensor mounted on the electronic device.

The control module 520 is configured to determine whether the coordinate data exceeds a data range corresponding to a preset state of the electronic device, and to disable the electronic device when the coordinate data exceeds the data range corresponding to the preset state.

Corresponding to the three implementations provided in step S320 of the method 300 (FIG. 3), the control module 520 may determine whether the data range corresponding to the preset state is exceeded using one of the following three determining modules.

The first determining module is configured to determine whether the coordinate data exceeds the data range corresponding to the preset state based on a vertical coordinate of the electronic device. Specifically, when determining a change of the vertical coordinate has exceeded a first preset range for a predetermined amount of time, the first determining module may conclude that the electronic device is no longer in the preset state.

The second determining module is configured to determine whether the coordinate data exceeds the data range corresponding to the preset state based on a vertical coordinate of the electronic device. Specifically, when determining a change of the vertical coordinate exceeds a second preset range, the first determining module may conclude that the electronic device is no longer in the preset state.

The third determining module is configured to determine whether the coordinate data exceeds the data range corresponding to the preset state based on a horizontal coordinate of the electronic device. Specifically, when determining a change of the horizontal coordinate has exceeded a third preset range for a predetermined amount of time, the third determining module may conclude that the electronic device is no longer in the preset state.

Still referring to FIG. 5, as an example, the control module 520 may include a determining module 522, which may be one of the first determining module, the second determining module, and the third determining module.

The alarm module 530 is configured to generate an alarm when the control module 520 determines that the coordinate data exceeds the data range corresponding to the preset state.

The communication module 540 is configured to send an alarm message to a preset mobile terminal, such as a mobile phone, at the same time when the alarm module 530 generates that alarm, such that a user of the preset mobile terminal can check the state of the electronic device in real time.

The communication module 540 may connect to a wireless network based on any suitable communication standard, such as Bluetooth, WiFi, 2G, 3G, 4G, or a combination thereof.

With respect to the systems in the above embodiments, the specific manners of performing operations by individual modules therein have been described in detail in the embodiments regarding the methods, which are not elaborated herein again.

The system embodiments substantially correspond to the above-described method embodiments. As such, functions of the individual parts in the disclosed system may be referred to corresponding steps of the disclosed methods. The above-described system embodiments are merely illustrative, in which a module/unit as a separate component may or may not be physically separated, a component displayed as a module/unit may or may not be a physical module/unit, i.e. located at a place, or be distributed on multiple network modules/units. A part or all of the modules/units may be selected according to practical needs so as to achieve the object of the solution provided by the present disclosure, which may be understood and implemented by those skilled in the art without creative endeavor.

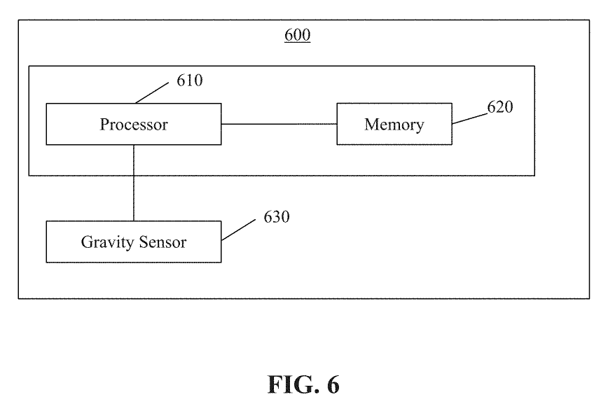

FIG. 6 is a block diagram of an electronic device 600, according to an exemplary embodiment of the present disclosure. As shown in FIG. 6, the electronic device 600 includes a processor 610 and a memory 620.

The memory 620 is configured to store instructions executable by the processor 610. The processor 610 is configured to execute the instructions to: acquire coordinate data of the electronic device 600; determine whether the coordinate data exceeds a data range corresponding to a preset state of the electronic device 600; and disable the electronic device 600 when the coordinate data exceeds the data range. Details regarding the operation of the processor 610 can be referred to the above method embodiments, which are not repeated herein.

The electronic device 600 may also be mounted with a gravity sensor 630 configured to acquire the coordinate data of the electronic device 600.

In example embodiments, the present disclosure also provides a non-transitory computer-readable storage medium including instructions. These instructions may be executed by a processor, such as the processor 620, to perform the methods described above. For example, the non-transitory computer-readable storage medium may be a read-only memory (ROM), a random access memory (RAM), a CD-ROM, a magnetic tape, a floppy disk, an optical data storage device, etc.

According to the description of the above embodiments, it should be understood by those skilled in the art that, the exemplary embodiments described herein may be realized by software, or hardware, or a combination of software and hardware. Therefore, technical solutions of the embodiments of the present disclosure may be embodied by a form of software product. This software product may be stored in a non-transitory storage medium (e.g., a CD-ROM, a U-disk, or a removable hard disk, etc.) or on a network, and may include instructions to enable a computing device (e.g., a personal computer, a server, a mobile terminal, or network equipment) to perform the methods consistent with embodiments of the present disclosure.

The explanatory embodiments of the present disclosure have been shown and described as above. It would be appreciated that, the present disclosure is not limited to the detailed structures, setting modes, or implementations described herein. Instead, the present disclosure is intended to cover various modifications and equivalent arrangements within the spirit and scope of the appended claims.

What is claimed is:

1. A method for protecting an electronic device, comprising:
acquiring coordinate data of the electronic device;
determining whether the coordinate data exceeds a data range corresponding to a preset state of the electronic device; and
disabling the electronic device when the coordinate data exceeds the data range corresponding to the preset state.

2. The method according to claim 1, wherein the coordinate data of the electronic device is acquired by a gravity sensor mounted on the electronic device.

3. The method according to claim 1,
wherein the coordinate data comprises a vertical coordinate, and
wherein the determining of whether the coordinate data exceeds the data range corresponding to the preset state of the electronic device further comprises:
when it is determined that a change of the vertical coordinate has exceeded a predetermined range for a predetermined amount of time, determining that the coordinate data exceeds the data range corresponding to the preset state of the electronic device.

4. The method according to claim 1,
wherein the coordinate data comprises a vertical coordinate, and
wherein the determining of whether the coordinate data exceeds the data range corresponding to the preset state of the electronic device further comprises:
when it is determined that a change of the vertical coordinate exceeds a predetermined range, determining that the coordinate data exceeds the data range corresponding to the preset state of the electronic device.

5. The method according to claim 1,
wherein the coordinate data comprises a horizontal coordinate, and
wherein the determining of whether the coordinate data exceeds the data range corresponding to the preset state of the electronic device further comprises:
when it is determined that a change of the horizontal coordinate has exceeded a predetermined range for a predetermined amount of time, determining that the coordinate data exceeds the data range corresponding to the preset state of the electronic device.

6. The method according to claim 1, further comprising:
when the coordinate data exceeds the data range corresponding to the preset state, generating an alarm, and sending an alarm message to a preset mobile terminal in real time, the alarm message indicating a current state of the electronic device.

7. A system for protecting an electronic device, comprising:
a processor; and
a memory configured to store instructions executable by the processor;
wherein the processor is configured to:
acquire coordinate data of the electronic device;
determine whether the coordinate data exceeds a data range corresponding to a preset state of the electronic device; and
disable the electronic device when the coordinate data exceeds the data range corresponding to the preset state.

8. The system according to claim 7, wherein the processor is further configured to acquire the coordinate data of the electronic device via a gravity sensor mounted on the electronic device.

9. The system according to claim 7,
wherein the coordinate data comprises a vertical coordinate, and
wherein the processor is further configured to:
when determining a change of the vertical coordinate has exceeded a predetermined range for a predetermined amount of time, determine that the coordinate data exceeds the data range corresponding to the preset state of the electronic device.

10. The system according to claim 7,
wherein the coordinate data comprises a vertical coordinate, and
wherein the processor is further configured to:
when determining a change of the vertical coordinate exceeds a predetermined range, determine that the coordinate data exceeds the data range corresponding to the preset state of the electronic device.

11. The system according to claim 7,
wherein the coordinate data comprises a horizontal coordinate, and
wherein the processor is further configured to:
when determining a change of the horizontal coordinate has exceeded a predetermined range for a predetermined amount of time, determine that the coordinate data exceeds the data range corresponding to the preset state of the electronic device.

12. The system according to claim 7, wherein the processor is further configured to:
generate an alarm when the coordinate data exceeds the data range corresponding to the preset state.

13. The system according to claim 12, wherein the processor is further configured to:
when the coordinate data exceeds the data range corresponding to the preset state, send an alarm message to a preset mobile terminal in real time, the alarm message indicating a current state of the electronic device.

14. An electronic device, comprising:
a processor; and
a memory configured to store instructions executable by the processor;
wherein the processor is configured to:
acquire coordinate data of the electronic device;
determine whether the coordinate data exceeds a data range corresponding to a preset state of the electronic device; and
disable the electronic device when the coordinate data exceeds the data range corresponding to the preset state.

15. The electronic device according to claim 14, further comprising a gravity sensor mounted on the electronic device and configured to acquire the coordinate data of the electronic device.

16. The electronic device according to claim 14,
wherein the coordinate data comprises a vertical coordinate, and
wherein the processor is further configured to:
when determining a change of the vertical coordinate has exceeded a predetermined range for a predetermined amount of time, determine that the coordinate data exceeds the data range corresponding to the preset state of the electronic device.

17. The electronic device according to claim 14,
wherein the coordinate data comprises a vertical coordinate, and
wherein the processor is further configured to:
when determining a change of the vertical coordinate exceeds a predetermined range, determine that the coordinate data exceeds the data range corresponding to the preset state of the electronic device.

18. The electronic device according to claim 14,
wherein the coordinate data comprises a horizontal coordinate, and
wherein the processor is further configured to:
when determining a change of the horizontal coordinate has exceeded a predetermined range for a predetermined amount of time, determine that the coordinate data exceeds the data range corresponding to the preset state of the electronic device.

19. The electronic device according to claim 14, wherein the processor is further configured to:
generate an alarm when the coordinate data exceeds the data range corresponding to the preset state.

20. The electronic device according to claim 19, wherein the processor is further configured to:
when the coordinate data exceeds the data range corresponding to the preset state, send an alarm message to a preset mobile terminal in real time, the alarm message indicating a current state of the electronic device.
